(19) United States
(12) Patent Application Publication
(10) Pub. No.: US 2004/0050355 A1
(43) Pub. Date: Mar. 18, 2004

(54) Remote engine control system

(76) Inventors: Chuck A. Harris, Taylorsville, UT (US); Alfred J. Morin II, Woods Cross, UT (US); John W. Brown, Holladay, UT (US)

Correspondence Address: JOHN C. STRINGHAM, WORKMAN, NYDEGGER & SEELEY, 1000 Eagle Gate Tower, 60 East South Temple, Salt Lake City, UT, 84111, US

(21) Appl. No.: 10/242,265

(22) Filed: Sep. 12, 2002

(51) Int. Cl. F02N 17/00

(52) U.S. Cl. 123/179.2

(57) ABSTRACT

An engine control system for remotely controlling an internal combustion engine. The engine control system includes a pair of relay systems that are connected with an ignition system and a starting system of the engine. The engine control system, according to the signals received from the transmitter, causes the relay systems to be either energized or de-energized as required to start and/or stop the engine. The relay systems are configured to be energized as either as long as a signal is received from the transmitter or to be energized even after the signal is no longer received. This enables the engine control system to temporarily activate the starting system of an engine until the engine is started while more permanently activating the ignition system until the engine is shut down, at which time the appropriate relay system is de-energized.

### BACKGROUND OF THE INVENTION

1. The Field of the Invention

The present invention relates to remotely controlling an internal combustion engine. More particularly, the present invention relates to systems and methods for remotely starting and stopping different types of internal combustion engines.

2. Background and Relevant Art

Internal combustion engines are made in a variety of different sizes and types and serve a variety of purposes. Diesel engines, spark ignited engines, and magneto ignition engines are examples of different types of internal combustion engines. These internal combustion engines are used in welders, painting systems, carpet cleaning systems, lawn mowers, pumps, compressors, and generators, to name a few. The different types of internal combustion engines also reflect the various industries that might use these engines.

Whatever their use, internal combustion engines are frequently turned on and then turned off for various reasons. This serves, for example, to conserve fuel or energy. In other instances, the engines are simply used on an intermittent basis and it is simply inconvenient or disadvantageous to have these engines running continuously. Thus, these engines are often stopped and started repeatedly. While these types of internal combustion engines are an indispensable part of many jobs, the engines are often remotely located from the engine operator when their use is required. A generator, for example, is used to distribute power to various locations that may be far from the actual location of the generator. In order to start or stop an engine such as a generator, the operator is required to leave whatever he or she was doing in order to either start or stop the internal combustion engine.

To combat this problem, several systems exist that permit an engine to be remotely started, for example. The primary problem with these systems is that they are often specific to particular engine types and are complex.

### BRIEF SUMMARY OF THE INVENTION

Internal combustion engines are manufactured in a variety of different types that include key started diesel ignited engines, key started spark ignited engines, key started magneto ignition engines, and the like. The present invention relates to systems and methods for remotely controlling internal combustion engines and has the additional advantage of being able to control multiple types of combustion engines. The present invention provides circuitry that is able to integrate with the existing starting and ignition systems of internal combustion engines regardless of the engine type.

An engine control system includes a receiver circuit that receives and processes signals received from a remote transmitter. The receiver circuit then activates or asserts an output signal(s) according to the signal that was received from the transmitter. The output signal(s) are used to control relay systems that are connected with the internal combustion engine.

One of the relay systems is energized as long as the transmitter is sending the signal to the receiver circuit. This is useful, for example, in activating the starting system of the internal combustion engines. Another relay system is typically connected to the receiver circuit through a circuit component that maintains the relay system in an energized state even after the transmitter is no longer transmitting. The relay system thus remains energized and the ignition system is able to continue functioning as required. The ignition system can be shut down by de-asserting the signal that controls this relay system, thereby de-energizing the relay system and shutting down the ignition system.

The ability to control whether a relay system is energized enables the engine control system to be connected to more than one engine type. This is accomplished by connecting at least one of the relay systems to either the receiver circuit or a relay controller through a switch. The switch can thus control whether the relay system is energized only while the transmitter is transmitting or whether the relay system remains energized when the transmitter is no longer transmitting.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of an engine control system for remotely controlling an internal combustion engine;

FIG. 2 is a schematic diagram of an engine control system;

FIG. 3 is a block diagram of an engine control system connected with an internal combustion engine that includes an autostart system;

FIG. 4 is a block diagram of an engine control system connected with a diesel ignited internal combustion engine;

FIG. 5 is a block diagram of an engine control system connected with a spark ignited internal combustion engine; and

FIG. 6 is a block diagram of an engine control system connected with a magneto ignition internal combustion engine.

### DETAILED DESCRIPTION OF THE PREFERRED EMBODIMENTS

The present invention relates to engine control systems for use in remotely controlling internal combustion engines. The present invention can be used with engines in industrial, commercial, and recreational industries. The types of internal combustion engines that can be remotely controlled by the present invention include, but are not limited to, engines with auto start systems, diesel ignited engines, spark ignited engines, magneto ignition engines, and the like. Specific engines that can be remotely controlled using the present invention include, but are not limited to, generator sets, pump engines, welders, compressors, and the like. These engines can be portable or stationary. One advantage of the present invention is that it can be used to remotely control more than one type of internal combustion engines using the same circuitry.

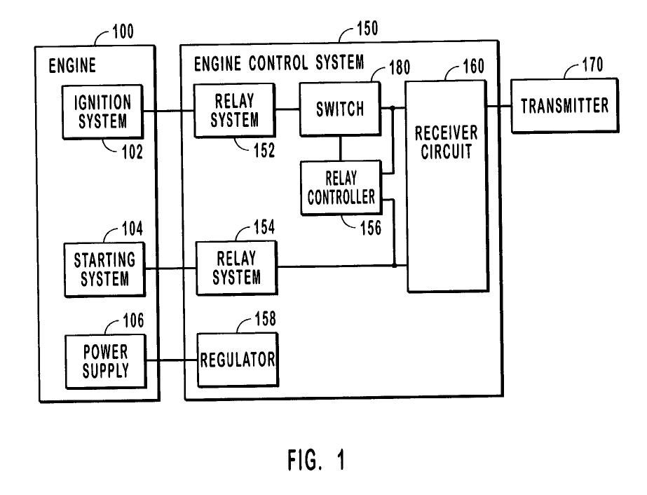

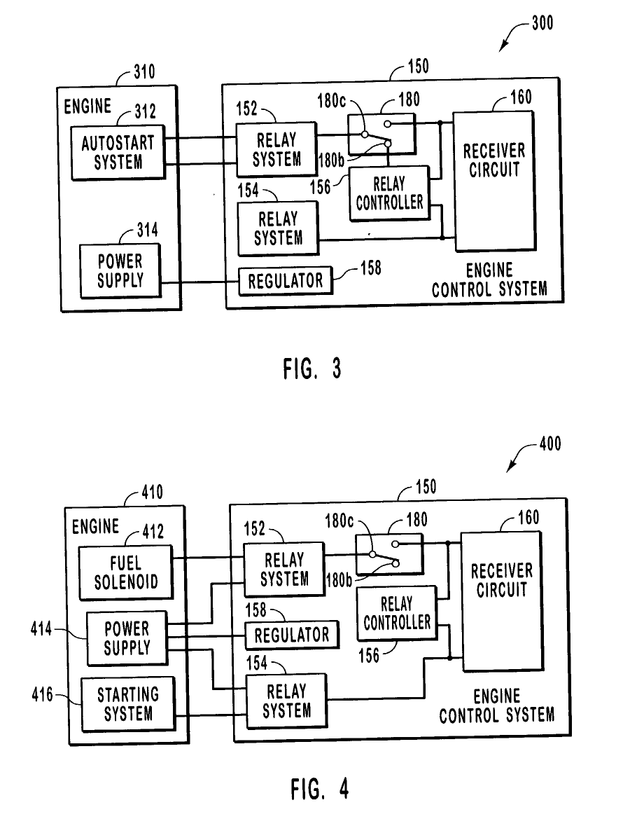

FIG. 1 illustrates a remotely controlled engine control system 150 that is coupled or connected with an internal combustion engine 100. The engine 100 includes an ignition system 102, a starting system 104 and a battery or power supply 106. As previously stated, the ignition system 102 and the starting system 104 are intended as representative of the ignition and starting systems of various engine types, even though the specific implementation of ignition systems and starting systems vary across engine types. The ignition system and starting system of a diesel engine, for instance, are different from the ignition system and starting system of a spark ignited engine. Specific implementations are discussed with reference to FIGS. 3 through 6.

The engine control system 150 is typically mounted in parallel to the existing starting system 104 and ignition system 102 of the engine 100. Mounting or connecting the engine control system 150 in this manner ensures that the engine 100 can be controlled independently of the engine control system 150. A key started engine, for example, can be started and stopped with either the key and/or the engine control system 150. Typically, the engine control system 150 has a master switch that disables the engine control system 150. This prevents, for example, the engine 100 from being remotely started or stopped inadvertently. The master switch is often used when maintenance is being performed on the engine and protects the operator from injury should someone attempt to remotely start the engine.

The engine control system 150 includes a pair of relay systems 152 and 154 and a relay controller 156. When the relay system 152 is energized, the ignition system 102 of the engine 100 is activated or powered. When the relay system 154 is energized the starter system 104 of the engine 100 is activated or powered. The regulator 158 is typically coupled to the battery or power supply 106 of the engine 100 and is used to provide the appropriate level of power to the various components of the engine control system 150. The output of the regulator 158 is typically about 5 volts.

The voltage supplied to the receiver circuit 160 is reduced in this example. The voltage supplied to the relay controller 156 is also reduced in order to ensure that the outputs of the receiver circuit 160 are recognized. In another embodiment, there is no need to reduce the voltage supplied to these components of the engine control system.

The receiver circuit 160 receives command signals (start signals and stop signals, for example) from the transmitter 170. These signals are typically used to both start and stop the engine 100. The receiver circuit 160, depending upon the signal received from the transmitter 170, will emit control signals or assert outputs that are sent to both the relay controller 156 and to the relay systems 152 and 154. The engine control system 150 also includes a switch 180 that can be set by a user to determine whether the relay system 152 receives a control signal from the relay controller 156 or the receiver circuit 160. The switch 180 is often implemented as a jumper or other connector whose position is dependent on engine type as described in more detail with respect to FIGS. 3 through 6.

The ignition system 102 and the starting system 104 are illustrative of engine components that are connected with the relay systems 152 and 154. Because the present invention is able to connect with different engine types, the terms starting system and ignition system are intended to include engine components that connect to the relay systems 152 and 154. For a diesel engine, for example, the term ignition system encompasses the fuel solenoid. For a magneto ignition engine, the ignition system encompasses the engine ground and the kill wire.

While the present invention is discussed in terms of spark ignited engines, magneto ignition engine (a type of spark ignited engine), diesel ignited engines, and engines with autostart systems, it is understood that these engine types are exemplary and are intended to encompass other engine types. For example, a spark ignited engine includes all types of spark ignited engine regardless of how the spark is generated and regardless of how the spark is triggered. As previously stated, one advantage of the present invention is the ability to interface with different types of internal combustion engines.

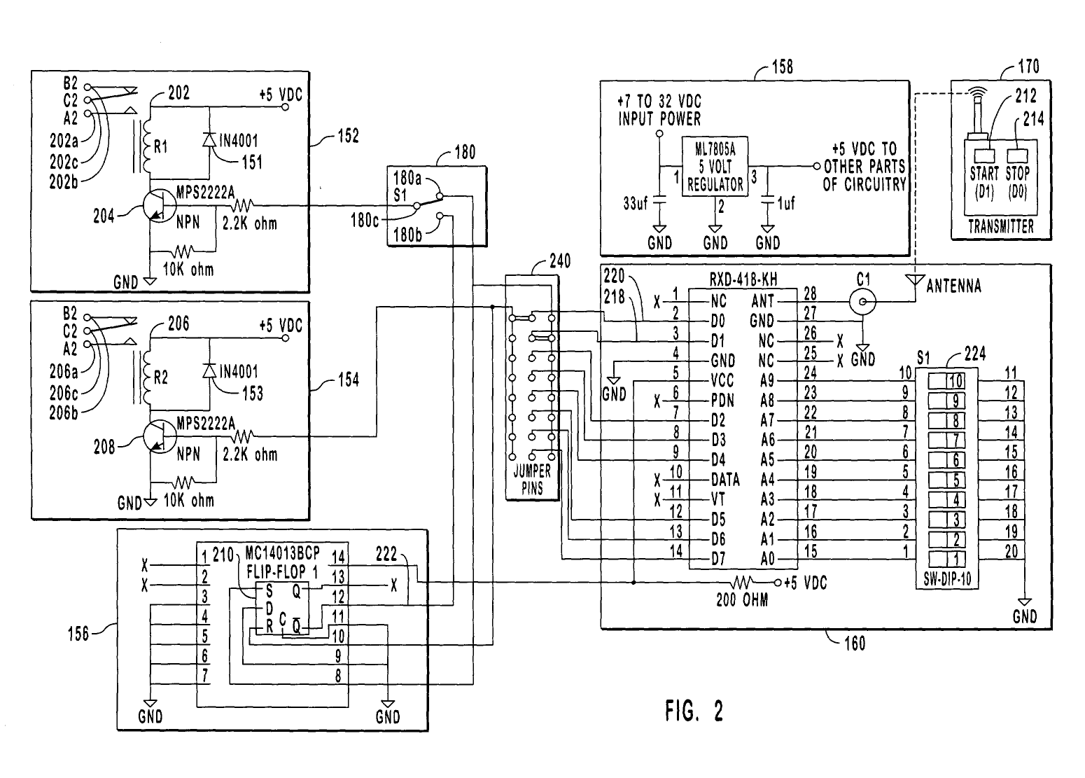

FIG. 2 is a block diagram the more fully illustrates an exemplary embodiment of the engine control system 150 shown in FIG. 1. The relay system 152 includes a relay 202 and a transistor 204. The base of the transistor 204 is driven by either the stop output 220 of the receiver circuit 160 or by a control output 222 of the relay controller 156. Whether the output 220 or the output 222 is connected to the base of the transistor 204 is determined by the switch 180. In other words, the output 222 of the relay controller 156 is connected with the base of the transistor 204 when the contact 180c of the switch 180 is connected with the contact 180b. When the contact 180c is connected with the contact 180a, the output 220 of the receiver circuit 160 is connected to the relay system 152. When the signal (output 220 or 222) driving the base of the transistor 204 causes the transistor 204 to be on, then the relay 202 is energized and the contact 202c is connected with the contact 202a. When the signal (output 220 or 222) driving the base of the transistor causes the transistor 204 to be off, then the relay 202 is de-energized and the contact 202c is connected with the contact 202b. The relay system 152 includes a diode 151 as protection from high currents when the relay is de-energized. The relay system 154 includes a diode 153 for the same reason.

The relay system 154 also includes a relay 206 and a transistor 208. The base of the transistor 208 is driven by the start output 218 of the receiver circuit 160. When the signal (output 218) driving the base of the transistor 208 is activated or turns the transistor 208 on, the relay 206 is energized and the contact 206c is connected with the contact 206a. When the signal or output driving the base of the transistor 208 is de-activated or turns the transistor 208 off, the relay 206 is de-energized and the contact 206c is connected with the contact 206b.

The relay controller 156 in this example is a flip-flop. The output 220 of the receiver circuit 160 is connected to the R input of the flip-flop 210 while the output 218 of the receiver circuit 160 is connected to the S input of the flip-flop 210. The output 222 of the flip-flop 210 is connected to the base of the transistor 204 of the relay system 152 when the contact 180c and the contact 180b of the switch 180 are connected. The switch 180 thus connects the relay system 152 to either the receiver circuit 160 or the relay controller 156. The switch 180 thus determines whether the output 222 of the flip-flop 210 drives the base of the transistor 204 or whether the output 220 of the receiver circuit 160 drives the base of the transistor 204.

The receiver circuit 160 also includes a dip switch 224 that is used to enter an address or code that matches an address or code received in the signals sent from the transmitter 170. The receiver circuit 160 receives signals from the transmitter 170 and based on the received signals, activates either the output 220 and/or the output 218 (assuming that the address or code received from the transmitter matches the code on the dipswitch 224). Power to all components of the engine control system illustrated in FIG. 2 is received from the regulator 158 which is typically connected to the battery or other power supply of the engine being remotely controlled by the engine control system.

The operation of the engine control system illustrated in FIG. 2 is determined in part by the position of the switch 180 as described above. The switch 180 may be implemented, for example, as a jumper or other connector. The switch 180 can be positioned by a user as required. When the start button 212 on the transmitter 170 is depressed, a signal is generated and sent to the receiver circuit 160. The receiver circuit 160 decodes the signal to determine whether the start button 212 or the stop button 214 was depressed. If the start button 212 was depressed, then the start output 220 is activated. The output 220 is connected, through jumper pins 240 to the relay system 154 and the reset input of the flip flop 210. Assuming that the contact 180c is connected with the contact 180b, the output 220 effectively drives the relay system 152 and the relay system 154. However, when the start button 212 is released, the output 220 is no longer active and the relay system 154 is de-energized.

The relay system 152 remains energized because the relay system 152 is driven by the control output 222 of the relay controller 156 or flip flop 210. When the stop button 214 is depressed, the stop output 218 is activated or asserted. The output 218 is connected to the S input of the flip flop. The output 218 sets the flip flop 210 and the relay system 152 is de-energized.

By controlling the relay systems as described, the engine control system can be connected to and remotely control various engine types as described below with reference to FIGS. 3 through 6. Reference will also be made to FIG. 2 during the description of the FIGS. 3-6. FIG. 3 illustrates an engine control system 150 that is connected with an engine 310 that includes an autostart system 312. The power supply 314 of the engine 310 is connected with the regulator 158, which provides power to the components of the engine control system 150. The contact 180c and the contact 180b of the switch 180 are connected in this example.

A position of the switch 180 is determined by engine type and by whether the user desires the relay system 152 to be energized or de-energized when the start/stop button of a transmitter is pressed. In other embodiments, the switch 180 can be implemented, for example, as a hard wired connection. In another embodiment, a logic circuit can be used whose output drives the relay system 152. In this embodiment, the inputs to the logic circuit would be the signals produced by the receiver circuit, and/or the relay controller.

FIG. 3, the relay system 152 is connected with the autostart system 312. The autostart system 312 typically includes two contact wires that are connected with the contact 202a and the contact 202c of the relay 202, which are illustrated in FIG. 2. With continued reference to FIG. 2, when the start button 212 is depressed, the output 220 is activated, which in turn resets the flip flop included in the relay controller 156. The output 222 of the relay controller energizes the relay system 152 such that the contact 202a and the contact 202c are connected. This enables the autostart system 312 of the engine 310 and starts the engine.

Because the relay system 152 is driven by the output of the relay controller 156, the relay system 152 remains energized even after the start button 212 is released. The engine 312 is stopped by depressing the stop button 214, which deactivates the signal driving the relay system 152 such that the contact 202c is no longer connected with the contact 202a. As a result, the autostart system 312 is disabled and the engine is stopped. For an engine with an autostart system, the engine control system 150 can omit the relay system 154 and the switch 180. The relay system 154 and the switch 180 permit the engine control system 150 to control other engine types as described herein.

FIG. 4 is a block diagram that illustrates an engine control system 150 connected with a diesel ignited engine 410. The power supply 414 of the engine 410 is connected to the regulator 158, the relay system 152 and the relay system 154. More particularly with reference to FIG. 2, the power supply 414 is connected with the contact 202c of the relay 202 in the relay system 152 and with the contact 206c of the relay 206 in the relay system 154. When the relay systems 152 and 154 are energized, the power is thereby supplied to the fuel solenoid 412 and the starting system 416 respectively of the engine 410.

The fuel solenoid 414 is also connected with the contact 202a of the relay system 152 while the starting system is connected with the contact 206a of the relay system 154. When the start button 212 is depressed, the output 220 is activated and the relay system 154 closes the contact 202a with the contact 202c such that power from the power supply 414 is provided to the starting system 416. At the same time, the output 220 drives the relay system 152 through the relay controller 156 because the contact 180c and 180b of the switch 180 are connected. When the start button 212 is released, the relay system 154 is de-energized and power is removed from the starting system 416. The relay system 152 remains energized, however, because it is driven by the output of a flip flop. In this manner, the diesel engine is started.

The diesel engine is stopped by de-energizing the relay system 152. This is accomplished by depressing the stop button 214, which sets the output of the relay controller such that the relay system 152 is de-energized. Note that the inverted output of the flip flop is connected with the relay system 152 in this example. Setting the flip flop thus de-energizes the relay system 152 while resetting the flip flop energizes the relay system 152. When the relay system 152 is de-energized, power is removed from the fuel solenoid 412 and the engine shuts down. In other words, the relay systems are used to connect and/or disconnect power with the starting system 416 and the fuel solenoid 412 as required. In general, the relay systems are used to connect and/or disconnect power to the starting systems and ignition systems of the internal combustion engine. As previously mentioned, the term ignition system would encompasses the engine components that are connected with the relay system 152.

FIG. 5 is a block diagram that illustrates an engine control system connected with a spark ignited engine 510. The power supply 514 of the engine 510 is connected to the regulator 158, the relay system 152 and the relay system 154. More particularly with reference to FIG. 2, the power supply 514 is connected with the contact 202c of the relay 202 in the relay system 152 and with the contact 206c of the relay 206 in the relay system 154. When the relay systems 152 and 154 are energized, the power is thereby supplied to the ignition system 512 and the starting system 516 respectively of the engine 510.

The ignition system 512 is also connected with the contact 202a of the relay system 152 while the starting system 516 is connected with the contact 206a of the relay system 154. When the start button 212 is depressed, the output 220 of the receiver circuit is activated and the relay system 154 closes the contact 202a with the contact 202c such that power from the power supply 414 is provided to the starting system 516. At the same time, the output 220 drives the relay system 152 through the relay controller 156 because the contact 180c and 180b of the switch 180 are connected. When the start button 212 is released, the relay system 154 is de-energized. The relay system 152 remains energized, however, because it is driven by the output of a flip flop. In this manner, the spark ignited engine is started.

The spark ignited engine is stopped by de-energizing the relay system 152. This is accomplished by depressing the stop button 214, which sets the output of the relay controller such that the relay system 152 is de-energized. The operation of the engine control system 150, with respect to a spark ignited engine and a diesel ignited engine are similar. One difference is related to the engine components that are connected with the relay systems 152 and 154.

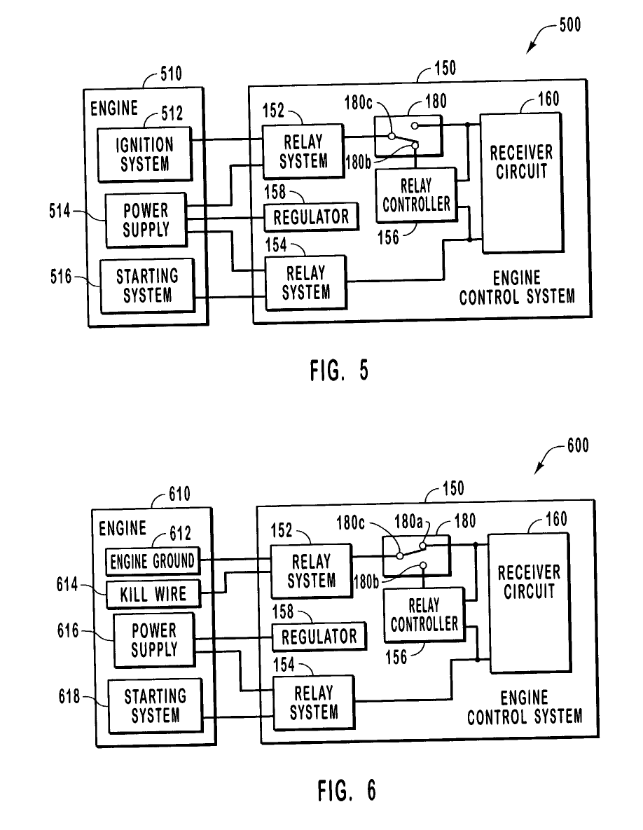

FIG. 6 is a block diagram that illustrates an engine control system 150 connected with a magneto ignition engine 610. As with the other examples described herein, the engine control system 150 is typically installed in parallel such that the engine may be controlled remotely or using the existing engine components. In the magneto ignition engine 610, the relay system 154 is connected with the power supply 616 and the starting system 618 of the engine 610. The power supply 616 is also connected with the regulator 158 such that the regulator 158 may provide power to the engine control system.

More specifically, with reference to FIG. 2, the power supply 616 is connected with the contact 206c of the relay 206 and the starting system 618 is connected with the contact 206a of the relay 206. When the start button 212 is pressed, the output 220 is active and drives the relay system 154 thereby closing the contacts 206c and 206a. Thus, the power supply 616 is connected through the closed contacts with the starting system 618. When the start button 212 is released, the relay 206 id de-energized.

Because the contact 180c and the contact 180a of the switch 180 are connected, the output 218 of the receiver circuit 160 is connected with the relay system 152. Also, the relay controller 156 is no longer necessary for this particular embodiment even though the relay controller 156 may be included in the engine control system 150.

The relay system 152 is connected with the engine ground 612 and a kill wire 614. More particularly, the engine ground 612 is connected to the contact 202c of the relay 202 and the kill wire 614 is connected with the contact 202a of the relay 202. When the stop button 214 is pressed, the relay system 152 is energized and the contacts 202c and 202a are closed. This connects the kill wire 614 to the engine ground 612 and kills or stops the engine 610. When the stop button 214 is released, the relay system 152 is de-energized. In this manner, the magneto ignition engine 610 can be remotely controlled.

Returning to FIG. 2, the jump pins 240 are included in the engine control system. The jump pins 240 can be configured such that other outputs of the receiver circuit 160 can be connected as required. In one example, the transmitter 170 may have four start buttons and four stop buttons. Each button can be configured to correspond to a different output of the receiver circuit 160. In this case, four engine control systems can be coupled or connected to four different internal combustion engines. Different jump pins 240 will be connected to the various outputs of the receiver circuit on each engine control system. This enables the same transmitter to control up to four different engines by appropriately configuring the jump pins 240. For each engine, only two outputs of the receiver circuit 160 will have an effect. In this example, the outputs 220 and 218 are connected through the jump pins 240. On another engine, the outputs 220 and 218 will not be connected. Instead, another pair of outputs will be connected through the jump pins 240.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An engine control system for remotely controlling an internal combustion engine, the engine control system comprising:
a receiver circuit that generates a start output as long as a start signal is received from a transmitter and that generates a stop output as long as a stop signal is received from the transmitter;
a relay controller connected with the start output of the receiver circuit and with the stop output of the receiver circuit, wherein the relay controller generates a control output that is set when the start output is active and that is reset when the stop output is active;
a relay system that is connected with a switch that connects the relay system with either the start output of the receiver circuit or with the control output of the relay controller; and
a second relay system that is connected with the stop output of the receiver circuit, whereby the start signal starts the internal combustion engine and the stop signal stops the internal combustion engine.

2. An engine control system as defined in claim 1, wherein the receiver circuit further comprises a dip switch that stores a code, wherein the code is matched to a code included in both the start signal and the stop signal received from the transmitter.

3. An engine control system as defined in claim 1, wherein the relay controller further comprises a flip flop.

4. An engine control system as defined in claim 3, wherein the flip flop is an SR flip flop and the start output is connected with an S input of the SR flip flop and the stop output is connected with an R input of the SR flip flop.

5. An engine control system as defined in claim 1, further comprising a regulator that supplies power to the engine control system from a power supply of the internal combustion engine.

6. An engine control system as defined in claim 1, wherein the relay system further comprises a relay connected in series with a transistor, wherein a base of the transistor is connected with either the start output or the control output such that either the start output or the control output determines whether the relay is energized.

7. An engine control system as defined in claim 1, wherein the second relay system further comprises a relay connected in series with a transistor, wherein a base of the transistor is connected with the stop output, wherein the relay is energized when the stop output is activated and wherein the relay is de-energized when the stop output is not activated.

8. An engine control system as defined in claim 1, further comprising jumper pins such that other outputs of the receiver circuit may be activated by a transmitter.

9. An engine control system for remotely controlling an internal combustion engine, the engine control system comprising:
a first relay system that is connected with an ignition system of the internal combustion engine, wherein power is supplied to the ignition system when the first relay system is energized;
a second relay system that is connected with a starting system of the internal combustion engine, wherein power is supplied to the starting system when the second relay system is energized;
a receiver circuit that receives a command signal from a transmitter, wherein the receiver circuit asserts a start output if the command signal is a start signal and asserts a stop output is the command signal is a stop signal, wherein the start output starts the internal combustion engine and the stop output stops the internal combustion engine;
a relay controller that has a control output that is determined by the command signal; and
a switch that connects the first relay system to either the receiver circuit or the relay controller according to a type of the internal combustion engine.

10. An engine control system as defined in claim 9, wherein the first relay system further comprises a relay connected in series with a transistor, wherein the transistor is on and the relay is energized when the control output is asserted and the switch connects the first relay system with the relay controller and wherein the transistor is on as long as the start output of the receiver circuit is asserted and the switch connects the first relay system with the receiver circuit.

11. An engine control system as defined in claim 9, wherein the second relay system comprises a relay in series with a transistor, wherein the transistor is on and the relay is energized as long as the stop output of the receiver circuit is asserted.

12. An engine control system as defined in claim 9, wherein the receiver circuit further comprises a dip switch that stores a code such that the command signal can generate outputs only when the command signal includes the code.

13. An engine control system as defined in claim 9, wherein the internal combustion engine is a generator and the first relay system is connected with an autostart system such that power is supplied to the autostart system when the first relay system is energized.

14. An engine control system as defined in claim 9, wherein the internal combustion engine is a magneto ignition engine and first relay system connects an engine ground with a kill wire when the first relay system is energized such that the magneto ignition engine shuts down, and wherein the second relay system connects a power supply with a starting system when the second relay system is energized.

15. An engine control system as defined in claim 9, wherein the internal combustion engine is a diesel ignited engine and the first relay system connects a power supply to a fuel solenoid when the first relay system is energized, and wherein the second relay system connects the power supply with a starting system.

16. An engine control system as defined in claim 9, wherein the internal combustion engine is a spark ignited engine and the first relay system connects a power supply to an ignition system when energized and wherein the second relay system connects a power supply to a starting system when energized.

17. An engine control system as defined in claim 9, wherein the relay controller further comprises a flip flop.

18. An engine control system as defined in claim 17, wherein the flip flop is an SR flip flop and the start output is connected with an S input of the SR flip flop and the stop output is connected with an R input of the SR flip flop.

19. An engine control system as defined in claim 9, further comprising a regulator that supplies power to the engine control system from a power supply of the internal combustion engine.

20. An engine control system for remotely controlling a generator, the engine control system comprising:
a relay system that is connected with an ignition system of the generator, wherein the relay system activates the ignition system of the generator when the first relay system is energized;
a relay controller that includes a flip flop; and
a receiver circuit that generates a start output as long as a start signal is received from a transmitter and that generates a stop output as long as a stop signal is received from the transmitter, wherein the start output is connected to the relay system through the relay controller such that the relay system is energized even after the start signal is no longer being transmitted, wherein the stop signal de-energizes the relay system by asserting the stop output.

21. An engine control system as defined in claim 20, wherein the relay system comprises a relay in series with a transistor, wherein a base of the transistor is connected with the start output through the relay controller.

22. An engine control system as defined in claim 20, wherein the ignition system comprises an autostart system, wherein a power supply of the generator is connected with the autostart system when the relay system is energized.

23. An engine control system as defined in claim 20, further comprising a second relay system and is energized as long as the stop output is activated, wherein the second relay system connects a power supply to the starting system of the generator when energized.

24. An engine control system as defined in claim 20, further comprising a regulator that supplies power to the engine control system from a power supply of the generator.

25. An engine control system for remotely controlling one or more types of internal combustion engines, the engine control system comprising:
a first relay system that is connected with an ignition system of an engine, wherein the first relay system activates the ignition system of the engine when the first relay system is energized;
a second relay system that is connected with a start system of the engine, wherein the second relay system activates the start system of the engine when the second relay system is energized;
a receiver circuit that generates a start output as long as a start signal is received from a transmitter and that generates a stop output as long as a stop signal is received from the transmitter,
a relay controller that includes a flip flop, wherein a control output of the relay controller is set by the start output and reset by the stop output of the receiver circuit; and
a switch that connects the first relay system with either the start output of the receiver circuit or the control output of the relay controller, wherein the switch is positioned according to a type of the internal combustion engine.

26. An engine control system as defined in claim 25, wherein the start output is connected to the first relay system through the relay controller such that the relay system is energized even after the start signal is no longer being transmitted, wherein the stop signal de-energizes the relay system by asserting the stop output which resets the relay controller.

27. An engine control system as defined in claim 25, wherein the switch connects the first relay system with the start output of the receiver circuit if the engine is a magneto ignition engine, wherein the switch connects the first relay system with the control output of the relay controller when the engine is one of a spark ignited engine or a diesel ignited engine.
